(19) United States
(12) Patent Application Publication
(10) Pub. No.: US 2011/0082692 A1
(43) Pub. Date: Apr. 7, 2011

(54) METHOD AND APPARATUS FOR REMOVING SIGNAL NOISE

(75) Inventors: Hyung Joon LIM, Suwon-si (KR); Ki Wan Eom, Suwon-si (KR); Weiwei Cui, Yongin-si (KR)

(73) Assignee: SAMSUNG ELECTRONICS CO., LTD., Suwon-si (KR)

(21) Appl. No.: 12/846,041

(22) Filed: Jul. 29, 2010

(30) Foreign Application Priority Data
Oct. 1, 2009 (KR) 10-2009-0093699

(51) Int. Cl. G10L 21/02

(52) U.S. Cl. 704/225; 704/226; 704/E21.002

(57) ABSTRACT

A method and apparatus for removing signal noise using multiple bands are provided. The noise removal apparatus may divide the entire frequency band into a plurality of sub-bands using a multiband filter that has characteristics similar to an auditory system of a human being and may effectively remove noise in each of the sub-bands according to a frequency subtraction scheme.

### CROSS-REFERENCE TO RELATED APPLICATION(S)

This application claims the benefit under 35 U.S.C. § 119(a) of Korean Patent Application No. 10-2009-0093699, filed on Oct. 1, 2009, in the Korean Intellectual Property Office, the entire disclosure of which is incorporated herein by reference for all purposes.

### BACKGROUND 1. Field

The following description relates to a method and apparatus for removing signal noise using multiple bands.

2. Description of Related Art

Various noise reduction schemes may extract a frequency characteristic from a speech signal according to a frequency subtraction scheme. The frequency subtraction scheme may remove a frequency characteristic of noise in a frequency band of a signal containing the noise. However, these various noise reduction schemes are based on the assumption that the frequency characteristic of the noise signal is uniformly distributed over the frequency band. However, these noise reduction schemes may be ineffective to remove actual noise.

### SUMMARY

In one general aspect, there is provided an apparatus for removing signal noise using multiple bands, the apparatus including a sub-band divider configured to divide a frequency band into a plurality of sub-bands with respect to an input power spectrum, and a noise removal unit configured to remove noise in the input power spectrum for each of the sub-bands.

The noise removal unit may remove noise in the input power spectrum for each of the sub-bands using a frequency subtraction scheme.

The sub-band divider may correspond to a filter bank that has similar characteristics as a cochlea of a human being, and may include a plurality of band pass filters that have a bandwidth similar to the rectangular bandwidth of an auditory characteristic of a human being.

The filter bank may have an impulse response characteristic based on a gain factor, a sampling period, an order of a filter, a center frequency of the filter, and a phase term for a complex filter.

The noise removal unit may include a plurality of noise estimators configured to estimate noise in each of the sub-bands, a plurality of signal-to-noise ratio (SNR) estimators configured to estimate an SNR of an input signal in each of the sub-bands based on the estimated noise, a plurality of spectrum subtraction units configured to subtract a spectrum from each of the sub-bands based on the estimated SNR, a plurality of energy calculators configured to calculate energy in each of the sub-bands, based on the subtracted spectrum, and a synthesizer configured to synthesize signals based on the calculated energy.

Each of the noise estimators may estimate a noise spectrum of a current frame using a noisy spectrum of the current frame and a noise spectrum of a previous frame.

Each of the spectrum subtraction units may subtract a noise power spectrum from a noisy speech power spectrum using an over subtraction factor that is determined based on the SNR.

In another aspect, there is provided a method for removing signal noise using multiple bands, the method including dividing an input signal into a plurality of sub-bands, and removing noise in each of the plurality of sub-bands of the input signal.

The dividing may include dividing the entire frequency band into the plurality of sub-bands using a multiband filter that has characteristics similar to an auditory system of a human being.

The removing may include removing noise for each of the sub-bands based on a frequency subtraction scheme.

The removing may include estimating noise in each of the sub-bands, estimating an SNR in each of the sub-bands based on the estimated noise, calculating an over subtraction factor in each of the sub-bands based on the estimated SNR to subtract a spectrum in each of the sub-bands, calculating energy in each of the sub-bands based on the subtracted spectrum, and synthesizing signals based On the calculated energy.

The estimating may include estimating a noise spectrum of a current frame using a noisy spectrum of the current frame and a noise spectrum of a previous frame.

The subtracting may include subtracting a noise power spectrum from a noisy speech power spectrum using an over subtraction factor that is determined based on the SNR.

In another aspect, there is provided a computer-readable storage medium having stored therein program instructions to cause a processor to execute a method for removing signal noise using multiple bands, the method including dividing an input signal into a plurality of sub-bands, and removing noise in each of the plurality of sub-bands of the input signal.

Other features and aspects should be apparent from the following description, the drawings, and the claims.

### BRIEF DESCRIPTION OF THE DRAWINGS

FIG. 1 is a diagram illustrating an example of an apparatus for removing signal noise using multiple bands.

FIG. 2 is a diagram illustrating an example of a magnitude and a frequency of a Gammatone filter bank.

FIG. 3 is a flowchart illustrating an example of a method for removing signal noise using multiple bands.

Throughout the drawings and the description, unless otherwise described, the same drawing reference numerals should be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein may be suggested to those of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, description of well-known functions and constructions may be omitted for increased clarity and conciseness.

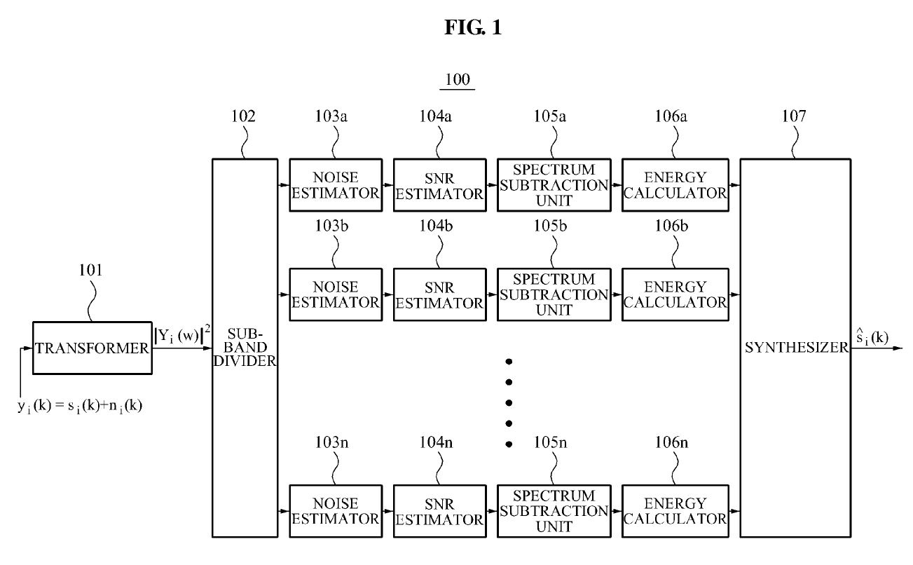

FIG. 1 illustrates an example of an apparatus for removing signal noise using multiple bands. Referring to FIG. 1, the noise removal apparatus 100 includes a transformer 101, a sub-band divider 102, noise estimators 103a, 103b, . . . , 103n, signal-to-noise ratio (SNR) estimators 104a, 104b, . . . , 104n, spectrum subtraction units 105a, 105b, . . . , 105n, energy calculators 106a, 106b, . . . , 106n, and a synthesizer 107.

The transformer 101 transforms an input noise signal to a frequency domain signal, and calculates a power spectrum. For example, the transformer 101 may perform a fast Fourier transform (FFT) on a single frame of the input noise signal represented as yᵢ(k)=sᵢ(k)+nᵢ(k) to convert the input noise signal to the frequency domain signal. In addition, the transformer 101 may calculate the power spectrum represented as |Yᵢ(w)|².

The sub-band divider 102 includes an auditory characteristic similar to a human being. The sub-band divider 102 divides an entire frequency band over the calculated spectrum into a plurality of sub bands. The sub-band divider 102 may correspond to a filter bank that includes a plurality of band pass filters that matches an equivalent rectangular bandwidth scale of an auditory system of the human being. The sub-band divider 102 may divide the frequency band, using the plurality of band pass filters, into the plurality of sub-bands along a frequency band through which the power spectrum passes.

The filter bank may have an impulse response characteristic based on, for example, a gain factor, a sampling period, an order of a filter, a center frequency of the filter, and a phase term for a complex filter. For example, the sub-band divider 102 may include a Gammatone filter bank modeling characteristics similar to the cochlea of a human being. The impulse response characteristic may be represented by the following Equation 1.

[Equation 1]

g(n)=A(nT)^{N-1}e^{-2πERB(f}_{c})^{nT} cos(2πf_{c}nT+φ)

In this example, “A” denotes the gain factor, “T” denotes the sampling period, “N” denotes the order of the filter, “f_{c}” denotes the center frequency of the filter, and “φ” denotes the phase term for a complex filter.

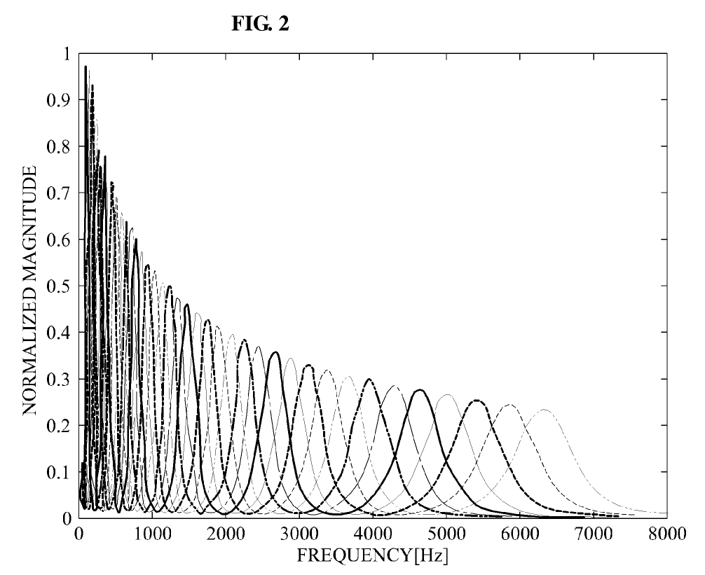

FIG. 2 illustrates an example of a magnitude and a frequency of a Gammatone filter bank. Referring to FIG. 2, the sub-band divider 102 of FIG. 1 may make a signal pass for each of the frequency bands over the entire frequency, and divide the frequency band into a plurality of sub-bands. For example, if the sub-band divider 102 includes forty band pass filters, the sub-band divider 102 may make the signal pass over each of the frequency bands for each of the forty band pass filters over the frequency band, and divide the frequency band into forty sub-bands.

The noise estimators 103a, 103b, . . . , 103n estimate noise in each of the sub-bands. For example, the noise estimators 103a, 103b, . . . , 103n may recursively estimate a noise spectrum of a current frame based on a noisy spectrum that contains noise of the current frame and a noise spectrum of a previous frame. For example, where Y₁(w, i) indicates a noisy power spectrum of a w^{th} frequency bin in a first sub-band of an i^{th} frame, and N₁(w, i) indicates a noise power spectrum of the w^{th} frequency bin in the first sub-band of the i^{th} frame, the noise estimators 103a, 103b, . . . , 103n may estimate the noise using a noise power spectrum estimation equation according to the following Equation 2.

$${N}_{l} ( w , i ) = \{ \begin{matrix}{N}_{l} ( w , i - 1 ) & if {XNR}_{l} ( w , i ) > α \\ ( 1 - β ) {N}_{l} ( w , i - 1 ) + β {Y}_{l} ( w , i ) & else\end{matrix} \\ {XNR}_{l} ( w , i ) = \frac{{Y}_{l} ( w , i )}{{N}_{l} ( w , i - 1 )} \qquad [ Equation 2 ]$$

For example, the noise estimator 103a may estimate the noise spectrum of the current frame based on the noisy spectrum of the current frame in the first sub-band where a signal passes through a first frequency over the entire frequency, and based on a noise spectrum of a previous spectrum.

As another example, the noise estimator 103b may estimate the noise spectrum of the current frame based on the noisy spectrum of the current frame in the second sub-band where the signal passes through a second frequency band over the entire frequency, and based on the noise spectrum of the previous spectrum.

In yet another example, the noise estimator 103n may estimate the noise spectrum of the current frame based on the noisy spectrum of the current frame in the n^{th} sub-frame where a signal passes through an n^{th} frequency band over the entire frequency band, and based on the noise spectrum of the previous spectrum.

The SNR estimators 104a, 104b, . . . , 104n estimate an SNR of an input signal in each of the sub-bands based on the noise estimated in the noise estimators 103a, 103b, . . . , 103n. The SNR estimators 104a, 104b, . . . , 104n may estimate the SNR in each of the sub-bands based on a noise power spectrum and a noisy power spectrum of the current frame. For example, where Y₁(w, i) indicates the noisy power spectrum of the w^{th} frequency bin in the first sub-band of the i^{th} frame, and N₁(w, i) indicates the noise power spectrum of the w^{th} frequency bin in the first sub-band of the i^{th} frame, the SNR estimators 104a, 104b, . . . , 104n may estimate the SNR according to the following Equation 3.

$${SNR}_{l} = 10 {log}_{10} ( \frac{{\sum }_{w} {\vert {Y}_{l} ( w , i ) \vert}^{2}}{{\sum }_{w} {\vert {N}_{l} ( w , i ) \vert}^{2}} ) \qquad [ Equation 3 ]$$

For example, the SNR estimator 104a may estimate the SNR based on the estimated noise power spectrum and the noisy power spectrum of the current frame in the first sub-band.

As another example, the SNR estimator 104b may estimate the SNR based on the estimated noise power spectrum and the noisy power spectrum of the current frame in the second sub-band.

In yet another example, the SNR estimator 104n may estimate the SNR based on the estimated noise power spectrum and the noisy power spectrum of the current frame in the n^{th} sub-band.

The spectrum subtraction units 105a, 105b, . . . , 105n subtract a spectrum from each of the sub-bands based on the SNR estimated by the SNR estimators 104a, 104b, . . . , 104n. For example, the spectrum subtraction units 105a, 105b, . . . , 105n may determine a value of an over subtraction factor y based on the SNR estimated by the SNR estimators 104a, 104b, . . . , 104n, and perform a spectrum subtraction according to Equation 4 below.

Through the spectrum subtraction, the spectrum subtraction units 105a, 105b, . . . , 105n may calculate an estimated clean speech power spectrum |Ŝ₁(w, i)|² in which the noise is removed according to the following Equation 4.

[Equation 4]

|Ŝₗ (w, i)|²=|Ŷₗ (w, i)|²−γ|\hat{N}ₗ (w, i)|²

For example, the spectrum calculation unit 105a may subtract a noise power spectrum within the first sub-band in which a value of the over subtraction factor γ determined based on the SNR is reflected, from a noisy power spectrum within the first sub-band. Based on the subtraction the spectrum calculation unit 105a may calculate the estimated clean speech power spectrum within the first sub-band.

As another example, the spectrum calculation unit 105b may subtract the noise power spectrum within the second sub-band in which the value of the over subtraction factor y determined based on the SNR is reflected, from a noisy power spectrum within the second sub-band. Based on the subtraction the spectrum calculation unit 105b may calculate the estimated clean speech power spectrum within the second sub-band.

In yet another example, the spectrum calculation unit 105n may subtract the noise power spectrum within the n^{th} sub-band including the value of the over subtraction factor y determined based on the SNR, from the noisy power spectrum within the n^{th} sub-band.

Based on the subtraction the spectrum calculation unit 105n may calculate the estimated clean speech power spectrum within the n^{th} sub-band.

The energy calculators 106a, 106b, . . . , 106n calculate energy over a power spectrum in the sub-bands based on the estimated clean speech power spectrum. The energy calculators 106a, 106b, . . . , 106n may calculate the energy over the power spectrum for each of the sub-bands based on the estimated clean speech power spectrum, according to the following Equation 5.

[Equation 5]

E(l,i)=Σ_{w}|Ŝ(w,i)|²

For example, the energy calculator 106a may calculate the energy of the first sub-band based on the estimated clean speech power spectrum in which noise is removed in the first sub-band.

As another example, the energy calculator 106b may calculate the energy of the second sub-band based on the estimated clean speech power spectrum in which noise is removed in the second sub-band.

In yet another example, the energy calculator 106n may calculate the energy of the n^{th} sub-band based on the estimated clean speech power spectrum in which noise is removed in the n^{th} sub-band.

The synthesizer 107 may synthesize signals based on the energy of each of the sub-bands that is calculated by the energy calculators 106a, 106b, . . . , 106n. For example, the synthesizer 107 may synthesize signals using the energy of the first sub-band through the n^{th} sub-band calculated by the energy calculators 106a, 106b, . . . , 106n. The synthesizer 107 may transform the synthesized signal to a time domain signal and output the time domain signal.

As described above, the noise removal apparatus 100 using the multiple bands may divide the entire frequency band into a plurality of sub-bands using a multiband filter that has characteristics of an auditory system similar to a human being. Accordingly, the noise removal apparatus 100 may effectively remove noise in each of the sub-bands according to a frequency subtraction scheme.

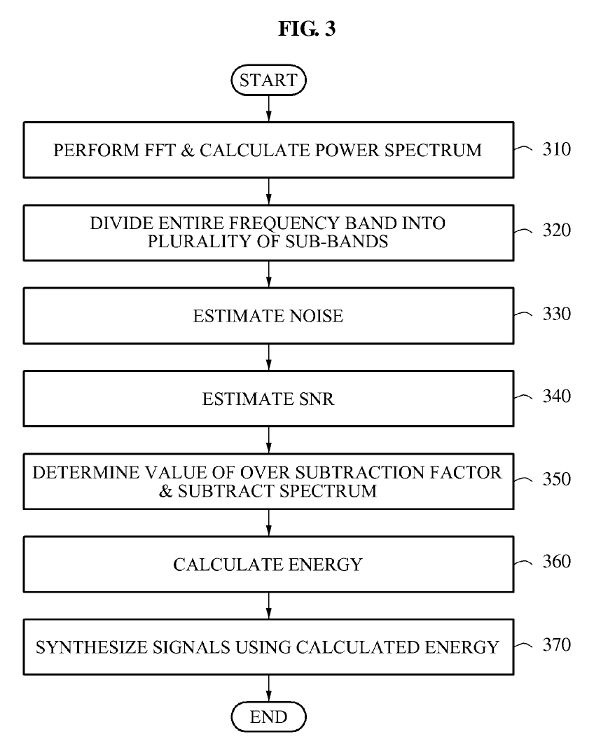

FIG. 3 is a flowchart that illustrates an example of a method for removing signal noise using multiple bands. Referring to FIG. 3, in operation 310, a noise removal apparatus transforms an input noise speech signal to a frequency domain signal, and calculates a power spectrum. In operation 310, the noise removal apparatus may perform a fast Fourier transform on a single frame of the input noise speech signal to convert the speech signal into the frequency domain signal. In addition, the noise removal apparatus may calculate the power spectrum.

In operation 320, the noise removal apparatus divides the entire frequency band over the calculated spectrum into a plurality of sub-bands. In operation 320, the noise removal apparatus may divide the entire frequency band over the calculated spectrum into the plurality of sub-bands. The sub-bands may be divided using a plurality of band pass filters, or using a filter bank that includes a plurality of band pass filters that is similar to the rectangular bandwidth scale of an auditory system of a human being. For example, the filter bank may have a Gammatone filter bank modeling characteristics of a cochlea of the human being, and an impulse response characteristic as given by the above Equation 1. The impulse repulse characteristic may include, for example, a gain factor, a sampling period, an order of a filter, a center frequency of the filter, and a phase term for a complex filter.

In operation 330, the noise removal apparatus estimates noise in each of the sub-bands. The noise removal apparatus may recursively estimate a noise spectrum of a current frame based on a noisy spectrum of the current frame and a noise spectrum of a previous frame. For example, where Y₁(w, i) indicates a noisy power spectrum of a w^{th} frequency bin in a first sub-band of an i^{th} frame, and N₁(w, i) indicates a noise power spectrum of the w^{th} frequency bin in the first sub-band of the i^{th} frame, the noise removal apparatus may estimate the noise based on a noise power spectrum estimation equation as shown in the above Equation 2.

For example, in operation 330, the noise removal apparatus may estimate the noise spectrum of the current frame based on the noisy spectrum of the current frame in the first sub-band where a signal passes through a first frequency over the entire frequency band, and based on a noise spectrum of a previous spectrum.

As another example, in operation 330, the noise removal apparatus may estimate the noise spectrum of the current frame based on the noisy spectrum of the current frame in the second sub-band where the signal passes through a second frequency band over the entire frequency band, and based on the noise spectrum of the previous spectrum.

In yet another example, in operation 330, the noise removal apparatus may estimate the noise spectrum of the current frame based on the noisy spectrum of the current frame in the n^{th} sub-frame where the signal passes through an n^{th} frequency band over the entire frequency, and based on the noise spectrum of the previous spectrum.

In operation 340, the noise removal apparatus estimates an SNR of an input signal in each of the sub-bands based on the estimated noise. In operation 340, the noise removal apparatus may estimate the SNR in each of the sub-bands based on a noise power spectrum and a noisy power spectrum of the current frame. For example, where Yᵢ(w, i) indicates the noisy power spectrum of the w^{th} frequency bin in the first sub-band of the i^{th} frame, and N₁(w, i) indicates the noise power spectrum of the w^{th} frequency bin in the first sub-band of the i^{th} frame, the noise removal apparatus may estimate the SNR using the above Equation 3.

For example, in operation 340, the noise removal apparatus may estimate the SNR based on the estimated noise power spectrum and the noisy power spectrum of the current frame in the first sub-band.

As another example, in operation 340, the noise removal apparatus may estimate the SNR based on the estimated noise power spectrum and the noisy power spectrum of the current frame in the second sub-band.

In yet another example, in operation 340, the noise removal apparatus may estimate the SNR based on the estimated noise power spectrum and the noisy power spectrum of the current frame in the n^{th} sub-band.

In operation 350, the noise removal apparatus subtracts a spectrum from each of the sub-bands based on the estimated SNR. In operation 350, the noise removal apparatus may determine a value of an over subtraction factor y based on the estimated SNR, and then perform a spectrum subtraction as given by the above Equation 4. Through this, the noise removal apparatus may calculate an estimated clean speech power spectrum in which the noise is removed.

For example, in operation 350, the noise removal apparatus may subtract a noise power spectrum within the first sub-band in which the value of the over subtraction factor y determined based on the SNR is reflected, from a noisy power spectrum within the first sub-band, and may calculate the estimated clean speech power spectrum within the first sub-band.

As another example, in operation 350, the noise removal apparatus may subtract the noise power spectrum within the second sub-band in which the value of the over subtraction factor y determined based on the SNR is reflected, from the noisy power spectrum within the second sub-band, and calculate the estimated clean speech power spectrum within the second sub-band.

In yet another example, in operation 350, the noise removal apparatus may subtract the noise power spectrum within the n^{th} sub-band in which the value of the over subtraction factor y determined based on the SNR is reflected, from the noisy power spectrum within the n^{th} sub-band, and calculate the estimated clean speech power spectrum within the n^{th} sub-band.

In operation 360, the noise removal apparatus calculates energy over a power spectrum in each of the sub-bands based on the estimated clean speech power spectrum. In operation 360, the noise removal apparatus may calculate the energy over the power spectrum for each of the sub-bands based on the estimated clean speech power spectrum as shown in the above Equation 5.

For example, in operation 360, the noise removal apparatus may calculate the energy of the first sub-band based on the estimated clean speech power spectrum in which noise is removed in the first sub-band.

As another example, in operation 360, the noise removal apparatus may calculate the to energy of the second sub-band based on the estimated clean speech power spectrum in which noise is removed in the second sub-band.

In yet another example, in operation 360, the noise removal apparatus may calculate the energy of the n^{th} sub-band based on the estimated clean speech power spectrum in which noise is removed in the n^{th} sub-band.

In operation 370, the noise removal apparatus synthesizes signals based on the calculated energy. For example, in operation 370, the noise removal apparatus may synthesize signals based on the energy of the first sub-band through the n^{th} sub-band calculated in operation 360, and may transform the synthesized signal to a time domain signal and output the time domain signal.

As described above, the noise removal method using the multiple bands may divide the entire frequency band into a plurality of sub-bands using a multiband filter that has characteristics of an auditory system of a human being and may effectively remove the noise in each of the sub-bands using a frequency subtraction scheme.

The methods described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media such as hard disks, floppy disks, and magnetic tape; optical media such as CD-ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for removing signal noise using multiple bands, the apparatus comprising:
a sub-band divider configured to divide a frequency band into a plurality of sub-bands with respect to an input power spectrum; and
a noise removal unit configured to remove noise in the input power spectrum for each of the sub-bands.

2. The apparatus of claim 1, wherein the noise removal unit is further configured to remove noise in the input power spectrum for each of the sub-bands using a frequency subtraction scheme.

3. The apparatus of claim 1, wherein the sub-band divider corresponds to a filter bank comprising similar characteristics as a cochlea of a human being, the filter bank comprising a plurality of band pass filters comprising a bandwidth similar to the rectangular bandwidth of an auditory characteristic of a human being.

4. The apparatus of claim 3, wherein the filter bank comprises an impulse response characteristic based on a gain factor, a sampling period, an order of a filter, a center frequency of the filter, and a phase term for a complex filter.

5. The apparatus of claim 1, wherein the noise removal unit comprises:
a plurality of noise estimators configured to estimate noise in each of the sub-bands;
a plurality of signal-to-noise ratio (SNR) estimators configured to estimate an SNR of an input signal in each of the sub-bands based on the estimated noise;
a plurality of spectrum subtraction units configured to subtract a spectrum from each of the sub-bands based on the estimated SNR;
a plurality of energy calculators configured to calculate energy in each of the sub-bands, based on the subtracted spectrum; and
a synthesizer configured to synthesize signals based on the calculated energy.

6. The apparatus of claim 5, wherein each of the noise estimators is further configured to estimate a noise spectrum of a current frame using a noisy spectrum of the current frame and a noise spectrum of a previous frame.

7. The apparatus of claim 5, wherein each of the spectrum subtraction units is further configured to subtract a noise power spectrum from a noisy speech power spectrum using an over subtraction factor that is determined based on the SNR.

8. A method for removing signal noise using multiple bands, the method comprising:
dividing an input signal into a plurality of sub-bands; and
removing noise in each of the plurality of sub-bands of the input signal.

9. The method of claim 8, wherein the dividing comprises dividing the entire frequency band into the plurality of sub-bands using a multiband filter that has characteristics similar to an auditory system of a human being.

10. The method of claim 8, wherein the removing comprises removing noise for each of the sub-bands based on a frequency subtraction scheme.

11. The method of claim 8, wherein the removing comprises:
estimating noise in each of the sub-bands;
estimating an SNR in each of the sub-bands based on the estimated noise;
calculating an over subtraction factor in each of the sub-bands based on the estimated SNR to subtract a spectrum in each of the sub-bands;
calculating energy in each of the sub-bands based on the subtracted spectrum; and
synthesizing signals based on the calculated energy.

12. The method of claim 11, wherein the estimating comprises estimating a noise spectrum of a current frame using a noisy spectrum of the current frame and a noise spectrum of a previous frame.

13. The method of claim 11, wherein the subtracting comprises subtracting a noise power spectrum from a noisy speech power spectrum using an over subtraction factor that is determined based on the SNR.

14. A non-transitory computer-readable storage medium having stored therein program instructions to cause a processor to execute a method for removing signal noise using multiple bands, the method comprising:
dividing an input signal into a plurality of sub-bands; and
removing noise in each of the plurality of sub-bands of the input signal.
